(19) United States
(12) Patent Application Publication
(10) Pub. No.: US 2026/0318163 A1
(43) Pub. Date: Oct. 15, 2026

(54) Hydrophilic Mud Loss Treatment Fluid

(71) Applicant: TOPI AS, Trondheim (NO)

(72) Inventor: Rune Flo, Trondheim (NO)

(21) Appl. No.: 19/476,248

(22) PCT Filed: Apr. 18, 2024
(86) PCT No.: PCT/NO2024/050092

§ 371 Date: Oct. 17, 2025

(30) Foreign Application Priority Data
Apr. 18, 2023 (NO) 20230420

(51) Int. Cl. E21B 21/00; C09K 8/06

(52) U.S. Cl. CPC E21B 21/003; C09K 8/06; C09K 2208/12

(57) ABSTRACT

A method for preventing drilling mud loss during drilling includes providing a hydrophilic drilling mud loss treatment fluid with water swellable hydrophilic polymer granules, a first water and a first hydrophobic oil. The granules, first water and first hydrophobic oil are mixed to partly swelled granules that are stored in a drilling pipe string borne tank behind a drill bit. The drill pipe string is used to drill. Upon detection of drilling mud loss, a tank outlet is opened and drilling mud loss treatment fluid is expelled to a main bore in the drill pipe string. The drilling mud loss treatment fluid is mixed with second water of drilling fluid in the main bore, transported with drilling fluid out through the drilling bit and penetrates the mud loss zone surrounding the bore hole and continues swelling with the second water and formation water, and reduces the undesired mud loss.

### PRIORITY CLAIM AND CROSS-REFERENCE

The present application is a National Stage Application, filed under 35 U.S.C. 371, of International Patent Application No. PCT/NO2024/219980A2, filed on Apr. 18, 2024, which claims the priority of Norwegian patent application Ser. No. 20/230,420, filed Apr. 18, 2023, each of which is incorporated herein by reference in its entirety.

### INTRODUCTION

This invention comprises a hydrophilic drilling mud loss treatment fluid. More specifically, it comprises water swellable hydrophilic polymer granules, so-called hyper-absorbent, hydrophilic polymer granules, a first water for partly swelling of the polymer granules, and a first hydrophobic oil which is inert vis-à-vis the water swellable polymer granules.

### BACKGROUND ART IN THE FIELD AND PRESENT PROBLEM

It is known from drilling of petroleum wells to utilize a hydrophilic drilling mud loss treatment fluid, in which the hydrophilic drilling mud loss fluid comprises “dry”/non-swelled water swellable hydrophilic polymer granules provided in an annular tank provided behind the drill collars and the drill bit, and where the annular tank is arranged to release the water swellable polymer granules to the drilling mud passing down from the drilling pipe string and the annular tank's central passage, and wherein the drilling mud brings with it the water swellable polymer granules out through the drill bit and to any mud loss zones surrounding the borehole, in order to prevent undesired loss of drilling mud due to fractures or porous zones in the bedrock. There are dry, water swellable polymers designed to swell ca. 60 times its volume in water. See FIG. 2 for this context with prior art. This is how to prevent undesired drilling mud loss. Therefore, so-called “lost circulation” is prevented, where this constitute a risk of losing control of the well. It is known from the specialized field to utilize such “dry” non-swelled water swellable hydrophilic polymer granules in an oil in an annular tank, wherein the oil with hydrophilic polymer granules is released through a valve from the annular tank. However, it is apparent from some instances that it is not possible to release non-swelled oil-born polymer granules from an annular tank via an outlet of the main bore in a borehole assembly and out through the drill bit due to potential problems with blockage due to premature swelling.

### SUMMARY

The invention is defined in the attached independent claims. Advantageous embodiments are described in the dependent patent claims.

### BRIEF DESCRIPTION OF THE DRAWINGS

The invention and background technique are shown in the attached patent drawings.

FIGS. 1A-1F illustrate overview outlines of an assembly and a drilling operation where the present invention can be utilized.

The overview of assembly and operation shows (a) preparation of a tank section or carrier sub on the hole; (b) polymer filling to tank section; (c) mounting of pressure compensator on the tank section, integrity testing; (d) RIH (lowering into the well) and start or continue drilling, detection of any possible mud loss during drilling; (e) ball drop or tool activation, release of drilling mud loss treatment fluid from carrier tool or tank tool to man ore and further to drill bit nozzles; (f) partly swelled polymer penetrate drilling mud loss cracks, limiting the cracks and continue to swell, ordinary circulation may be reestablished; (g) the particles (1p) of the drilling mud loss fluid (2) have further expanded in the cracks, continue drilling or pull out of the hole.

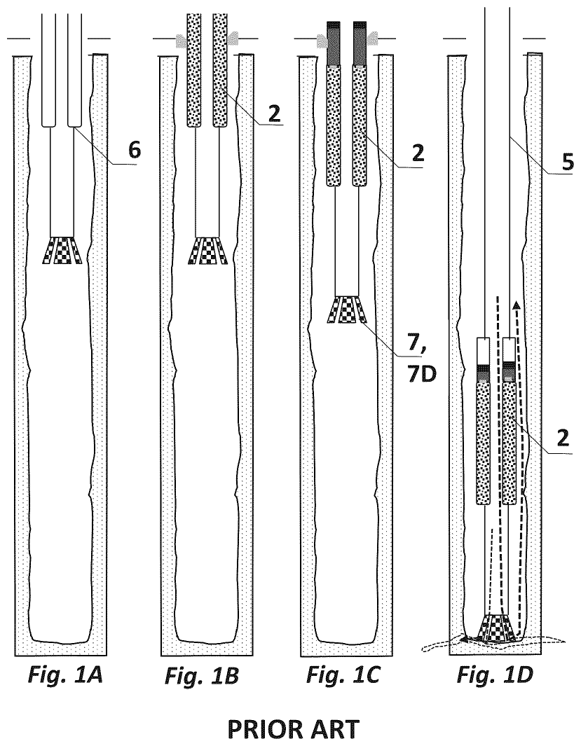

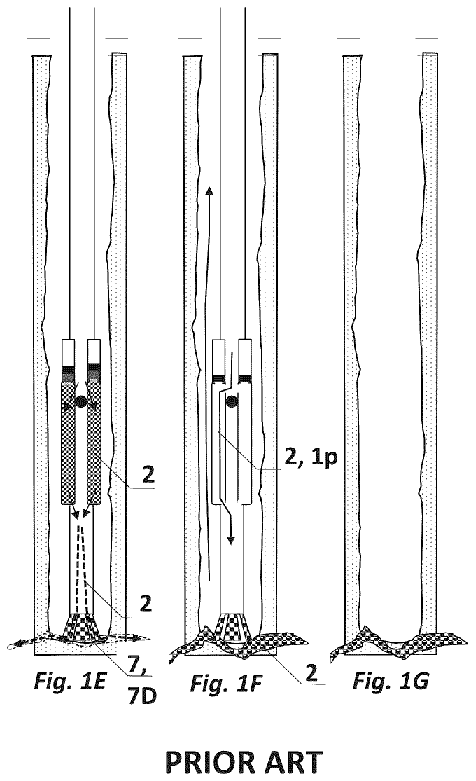

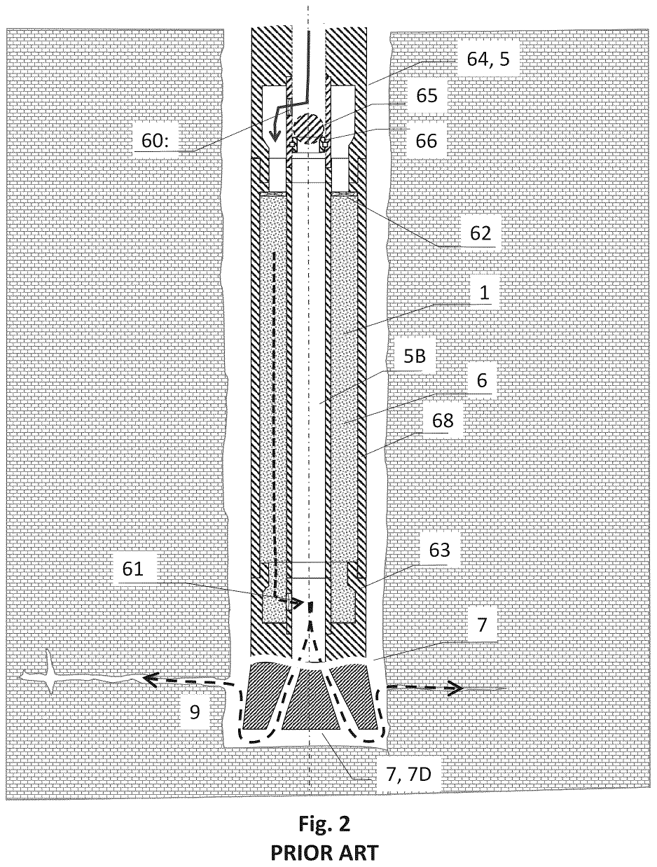

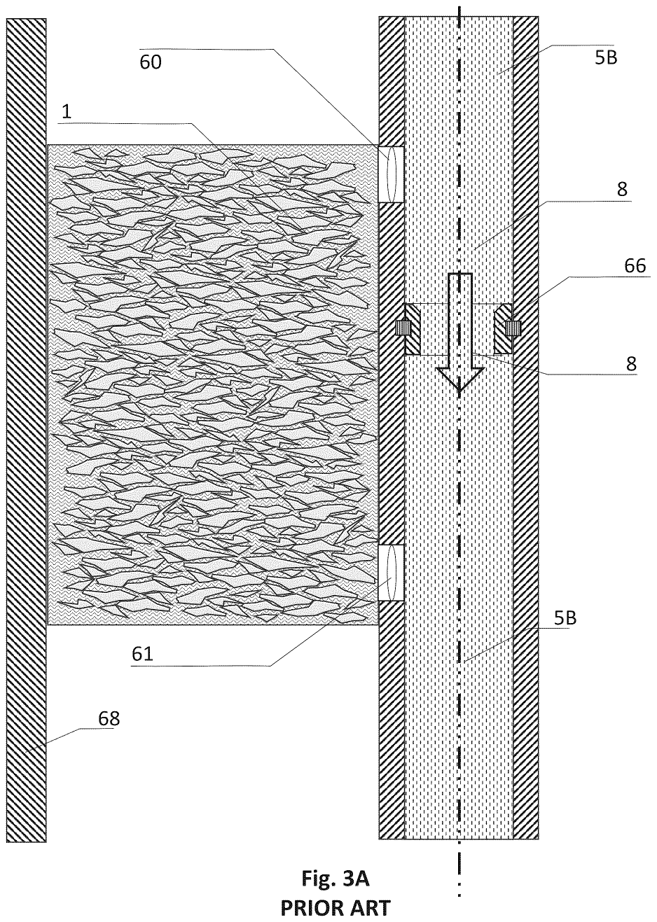

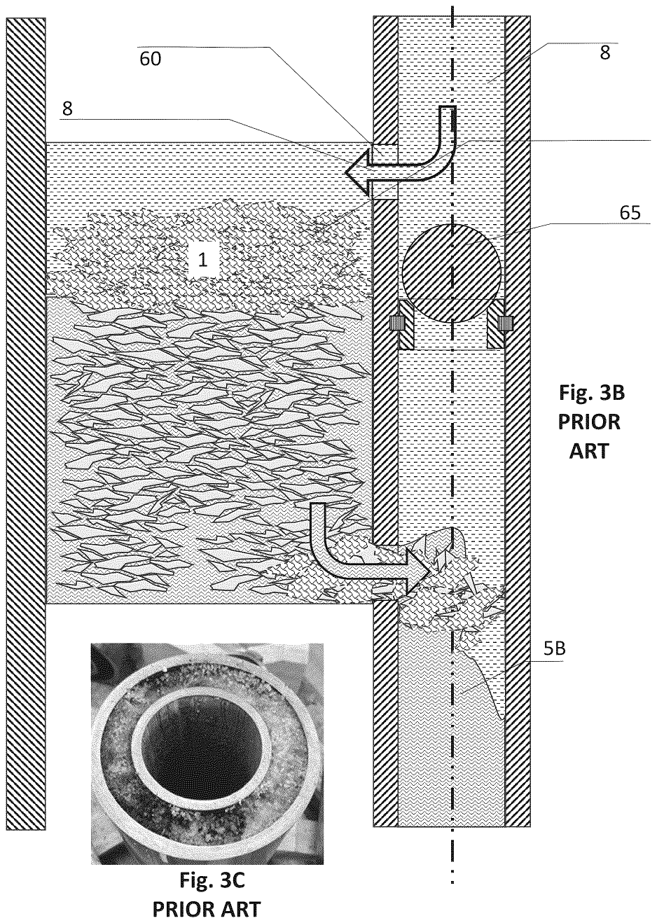

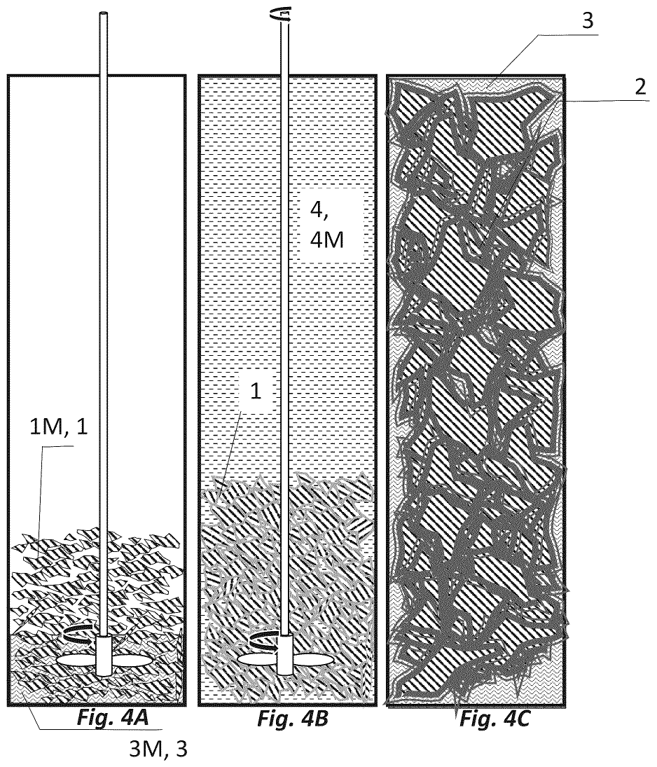

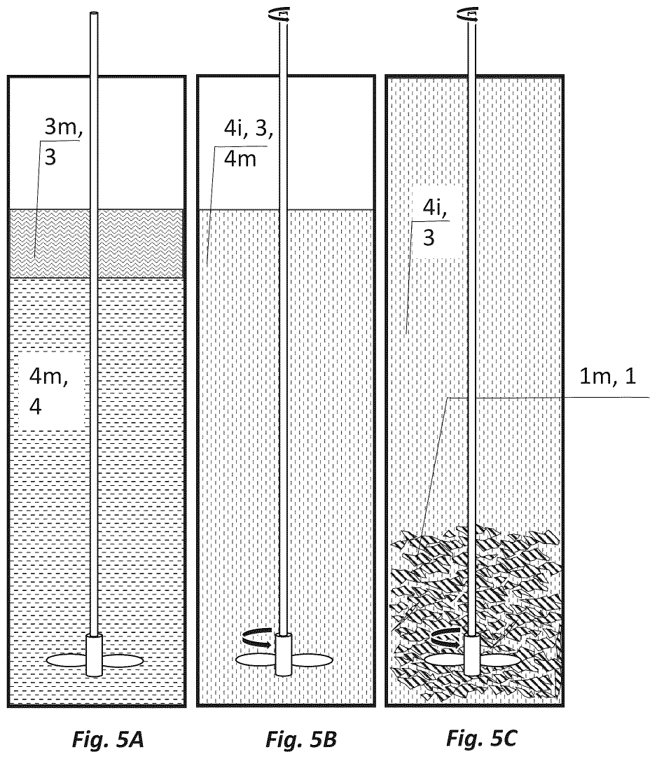

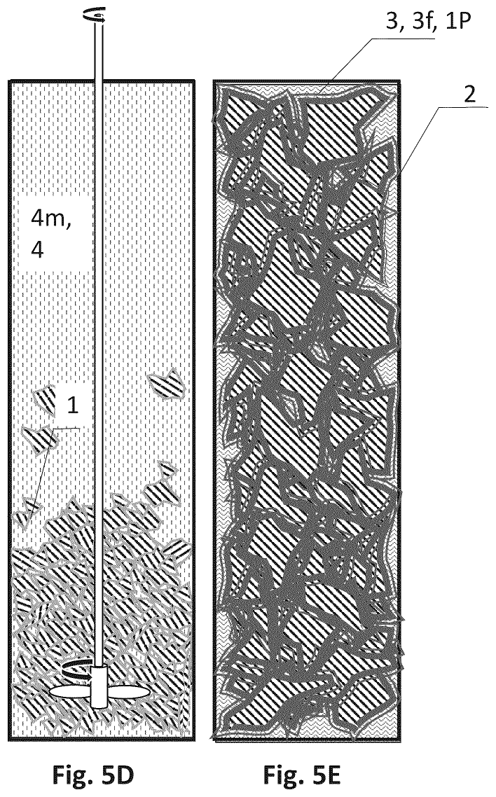

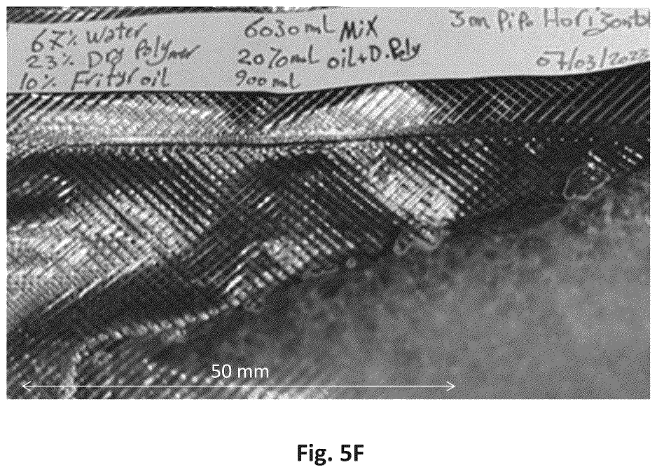

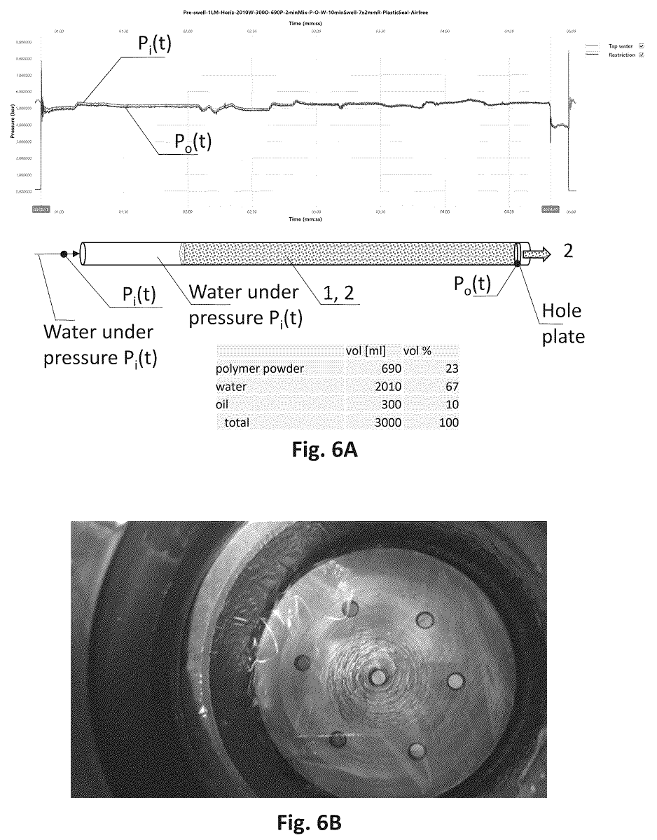

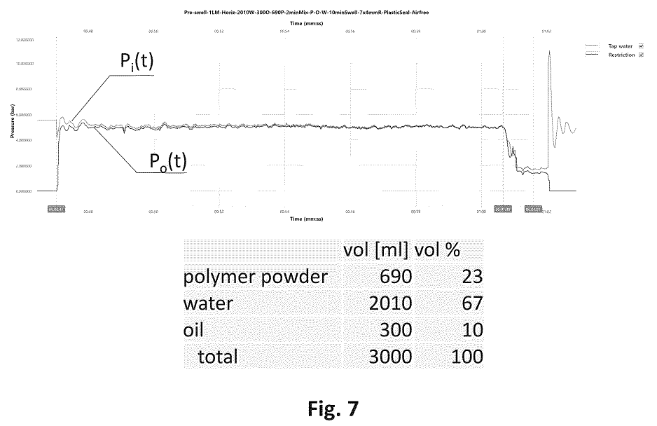

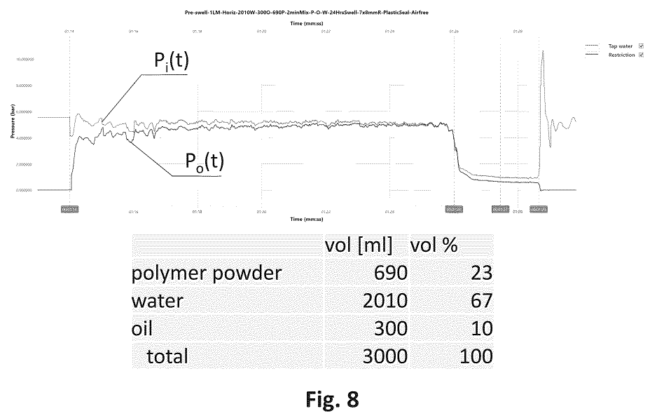

FIG. 1A illustrates preparation of the tank section, “carrier sub” in the drilling floor over a bottom hole assembly with a drill bit, preferably an annular tank section (6) provided in the rig floor, and with a drill collar and a drill bit suspended below, on the borehole.

FIG. 1B illustrates a step with filling of drilling mud loss treatment fluid (2) according to the invention in the tank section, preferably an annular tank section (6) above the drill collar, above the drill bit. One may fill the drilling mud loss treatment fluid (2) in the tank section (6) while the tank section is suspended in slips on the drilling floor. In an embodiment of the invention, one may utilize pre-filled tanks containing drilling mud loss treatment fluid (2) in the tank section (6).

FIG. 1C illustrates an embodiment of the invention in that one may mount a pressure compensator on top of the tank section (6) prior to running the tank section(s) down the borehole on a drilling pipe string (5), see below.

FIG. 1D illustrates a step where one may mount a drilling pipe string (5) and run the borehole assembly (7, 6, 5) down into the well for drilling. One may continuously monitor whether any drilling mud loss during drilling will occur.

FIG. 1E illustrates a step where one may have detected the occurrence of a drilling mud loss to an undesired high degree during drilling, for example through drilling in a manner that opens a connection to fractures or high-permeable bedrock, in which one may lose drilling mud to these, and one may decide to carry out a ball drop or tool activation in another manner, with a release of drilling mud loss treatment fluid (2) with partly swelling polymer particles (1p) from a carrier tool/tank section (6) to the main bore and further to drill bit nozzles.

FIG. 1F illustrates another step in which partly swelling polymer particles (1p), also during further swelling in the second water (4a), penetrates into drilling mud fractures, limiting the fractures and swelling further, and ordinary circulation can be reestablished.

FIG. 1G illustrates another step in which the drilling mud loss treatment fluid's (2) particles (1p) have expanded further in the fractures, and ordinary circulation can be reestablished, and one may continue drilling or extract from the hole POOH. The well is now under control.

FIG. 2 illustrates a lower part of a drill string (5) with a tank section (6) with a through main bore (5B) and with dry, water swellable particles/polymer granules in the annular tank. The water swellable particles run out of the tank (6) through outlets (61) to the main bore (5B) and meet water from the drilling mud here, and then run further via the nozzles (7D) to the bore hole (9) and further to a drilling mud loss zone surrounding the bore hole (9). This constitutes the context of the invention with prior art. The issue with prior art is in that there is a risk of blockage by the contents of the tank—the completely water-free but water swellable particles—is exposed to an uncontrolled mixture with water, blocking their outlet (61) from the tank (6).

FIG. 2 shows a prior art BHA pipe section with annular tank with water swelling drilling mud loss treatment particles, wherein the water swellable particles run out via the nozzles to the bore hole and further to a drilling mud loss zone surrounding the bore hole.

FIGS. 3A-3C show a main bore with drilling fluid through the dual wall pipe, bore fluid hydrous, the tank loaded with water swelling polymer granulate in flake form up to 2 mm in neutral low viscosity oil; the problem with prior art being low viscous oil drained from the tank and swellable polymer granulate block the annular tank and outlet; and an inserted photograph of a cross section of a blocked tank, where uncontrolled water swelling polymer mass particles not released from the annular tank have swelled when oil is drained and replaced by water from drill mud, and continue to swell and prevent drill mud loss preventative polymer particles from being released from the tank.

FIG. 3A illustrates the context of the invention in the from of prior art and problems tied to this. A main bore with drilling fluid runs through the central main bore (5B) through a dual wall concentric tank, which constitutes a part of BHA, the drilling fluid (8) being hydrous, whether it is water based mud or oil based mud, the tank is loaded up with water swellable polymer granules in flake form up to 2 mm in neutral, easily flowing, low viscosity oil.

FIG. 3B illustrates a possible resulting problem with prior art: the tank inlet and outlet are opened, and low viscosity (easily flowing) oil is separated in part and drained from the tank and water swellable polymer granules are blocking the annular tank and outlet. Hydrous WBM drilling fluid displaces a lot of the neutral oil which can be easily drained to the main bore 5B, flakes of prematurely swelling particles are blocking the outlet, and sticky, swelling polymer, hydrous mass is formed in and around the outlet of the main bore, preventing further release of water swellable polymer granules to the main bore that were supposed to run all the way to the drill bit.

FIG. 3C shows a recessed image of a cross-section of a blocked tank according to prior art. Water swelled polymer mass particles that have not been released from the annular tank have swelled when oil is drained and replaced with water from drilling mud, continuing to swell and preventing drilling mud loss preventing polymer particles from being released from the tank. The swelling mass forms a hard plug in the tank (6).

FIGS. 4A-4C illustrate steps in an embodiment of the invention; the first granule amount (1m) of “dry” hydrophilic polymer granules (1) is added to the first oil amount (3m) in order to form oil wet polymer granules (1) and the first water amount (4m), which then swells to form the drilling mud loss treatment fluid (2). The added first amount (4m) of the first water (4) is absorbed in the first granule amount of the first water swellable hydrophilic polymer granules (1), creating a pulpy mass of partly swelled polymer granules (1P) where each partly swelled polymer granule (1P) is surrounded by inert oil film (3f).

In the embodiment shown in FIGS. 4A-4C, the first polymer amount (1m) of “dry” hydrophilic polymer granulates (1) is added and the first oil amount (3m) and the first water amount (4m) which will swell into the drilling mud loss treatment fluid (2). In one embodiment of the invention, the first polymer amount (1m) of the first hydrophobic oil (3m) is oil wetted.

In FIGS. 5A-5E, an embodiment of the invention where one initially mixes the first water amount (4m) of the first water (4) with the first oil amount (3m) of the first hydrophobic oil (3), and stirs until an intermediary fluid (4i) of dispersed drops of hydrophobic oil (3) in the first water amount (4m) has been created. The first polymer amount (1m) of hydrophilic polymer granulate (1) is subsequently added, and everything is stirred to create the drilling mud loss treatment fluid (2). It can be stirred for 1 to 2 mins, for example 2 mins, to an intermediary fluid (4i) of dispersed drops of hydrophobic oil (3) I the first water amount (4m). Everything iss stirred, the water swellable, hydrophilic polymer granulates begin the partial swelling and taking up water, and the drilling mud loss treatment fluid (2) is created.

FIG. 5A-5C show a embodiment of the invention. One may mix the first water amount (4m) of the first water (4) with the first oil amount (3m) of the first hydrophobic oil (3), and stir until an intermediary fluid (4i) is formed, constitute dispersed drops of hydrophobic oil (3) in the first amount (4m). Subsequently, one may add the first granulate amount (1m) of hydrophilic polymer granules (1), after which one may stir in order to form the drilling mud loss treatment fluid (2), for example for two minutes.

FIGS. 5D and 5E illustrate a continuation of FIG. 5C. The entire mass must be stirred, the water swellable hydrophilic polymer granules (1) start the partly swelling by taking up water and becoming partly swelled hydrophilic polymer granules (1P), and the drilling mud loss treatment fluid (2) is formed. The first water amount (4m) of the first water (4) is absorbed in partly swelled hydrophilic polymer granules (1P), creating a drilling mud loss treatment fluid (2) partly swelled hydrophilic polymer granules (1P) with hydrophobic oil film (3f). The resulting drilling mud loss treatment fluid can withstand prolonged storage. In an embodiment of the invention, we have, after 10 minutes, pumped the entire mass from the manufacturing tank an over into a pipe, with outlet restrictions under various conditions and with various restriction diameters as described in FIGS. 6, 7 and 8.

FIG. 5F is an image of the resulting partly swelled polymer granules (1P) in a partly transparent sample bag containing the drilling mud loss treatment fluid (2).

FIG. 6A describes pressure P(t) for the drilling mud loss treatment fluid, here called “pre-swell” after 10 minutes of partly swelling in a 2 m Ø 50 mm pipe with a horizontal alignment, prior to release in a horizontal alignment for the pipe of the drilling mud loss treatment fluid (2) through a plate with Ø2 mm holes×7. The drilling mud loss treatment fluid (2) is pressured out through the hole plate before t=4:49-00:51=3 mins. 58 seconds (this constitutes a considerably longer time compared to when using a hole plate with 7 holes with Ø=4 mm, allowing everything to pass in t=13 s, see below, and it is assumed here that the upper granule size of the hard, water swellable polymer granules (1) up to 2 mm (and partly swelled-to-partly swelled polymer granules (1P) greater than 2 mm, albeit a bit rounded and softened, and with a lubricating oil film (3f)) will here be close to the limit of what can easily pass through the holes of the plate. The hole plate from the experiment is originally covered by a thin plastic film comparable to a rupture disc (67). The upper curve (red) indicates Pressure Pi(t) immediately before the water inlet at the beginning of the pipe, and lower curve (green) with pressure Po(t) by the outlet of the pipe. Note that the two pressure curves converge towards t=3 min 58 s, which indicates that at t=3 min 58 s, there will practically only be water left in the entire pipe, and one may surmise that the drilling mud loss treatment fluid (2) is pressured by the water like a cylindrical piston, where the pressure difference between incoming water and outgoing mass is gradually reduced over time as a function of the length of the remaining cylindrical piston of the drilling mud loss treatment fluid (2), i.e. that the water not merely penetrates as penetration channels through the drilling mud loss treatment fluid (2), but where, on the other hand, the drilling mud loss treatment fluid acts as a coherent mass, continuing to cover the pipe's cross-section until substantially all the mass has been pressed through the hole plate. We surmise that the drilling mud loss treatment fluid will act in the same manner when it is pressed out of an annular drill string born tank (6). A observation is that the drilling mud loss treatment fluid (2) has been pushed out after t=3 min 58 s when only water is flowing, and it only requires 1 bar less to push out the water than the drilling mud loss treatment fluid (2) through the Ø=2 mm holes.

FIG. 6A shows Pressure P(t) for the mud loss treatment fluid, here called “pre-swell” after 10 minutes of partial swelling in a pipe in a horizontal orientation, prior to release in horizontal orientation of the pipe of the mud loss treatment fluid (2) through a plate with seven 2 mm holes. Uppermost curve is the pressure Pi(t) immediately prior to the inlet of water at the beginning of the pipe, the lowermost curve pressure Po(t) by the outlet of the pipe. Experiment name: “Pre-swell 1LM-Horiz-2010W-3000-690P-2minMix-10minSwell-P-O-W-7x2mmR-PlasticSeal-Airfree”.

FIG. 6B is a photography of the restriction hole plate at the end of the pipe: Ø2 mm, 7 holes, the plate being covered by plastic foil which breaks under pressure.

FIG. 7 shows curves for pressure P(t) for the drilling mud loss treatment fluid, here called “pre-swell” after 10 minutes of partly swelling in a horizontally aligned pipe, before release in the horizontal alignment prior to the pipe of the drilling mud loss treatment fluid (2) through a plate with 4 mm holes×7. This is also the same setup as for FIG. 6A. The drilling mud loss treatment fluid (2) is pushed out through prior to 01:00-00:47=13 s, considerably faster than for Ø2 mm holes. The hole plate was originally covered by a thin plastic film. Upper curve (red) pressure Pi(t) just before the water inlet at the beginning of the pipe, lower curve (green) pressure Po(t) by the water outlet. Note that the two pressure curves converge towards t=13 s, indicating that at t=13 s, there is practically only water left in the entire pipe, and one may surmise that the drilling mud loss treatment fluid is pressed out as a cylindrical piston, where the pressure difference between incoming water and outgoing mass is reduced as a function of the length of the remaining cylindrical piston, i.e. that the water not merely penetrates the drilling mud loss treatment fluid (2), continuing to cover the pipe's/tank's cross-section until substantially all the mass has been pressed through the hole plate.

FIG. 7 shows Pressure P(t) for the mud loss treatment fluid, here called “pre-swell” after 10 minutes of partial swelling in a pipe in a horizontal orientation, prior to release in horizontal orientation of the pipe of the mud loss treatment fluid (2) through a plate with seven 4 mm holes. The mud loss treatment fluid (2) has been forced out prior to 01:00-00:47=12 s. Uppermost curve is the pressure Pi(t) immediately prior to the inlet of water at the beginning of the pipe, the lowermost curve pressure Po(t) by the outlet of the pipe. Experiment name: “Pre-swell 1 LM-Horiz-2010W-3000-690P-2minMix-10minSwell-P-O-W-7x2mmR-PlasticSeal-Airfree”.

FIG. 8 shows curves of pressure P(t) for the drilling mud loss treatment fluid, here called “pre-swell” after partly swelling for 24 hrs in a pipe with a vertical alignment, prior to release in a horizontal alignment for the pipe of the drilling mud loss treatment fluid (2) through a plate with Ø8 mm holes×7. All the drilling mud loss treatment fluid (2) is pressured out before t=1:26-0:14=12 s. This is somewhat, but not substantially faster than the experiment with hole plate with holes Ø=4 mm, but still substantially faster than for the experiment with hole plate with holes Ø=2 mm. The hole plate is originally covered by a thin plastic film. Upper curve (red) pressure Pi(t) just before the water inlet at the beginning of the pipe, lower curve (green) pressure Po(t) by the water outlet. Note that the two pressure curves converge towards t=12 s, indicating that at t=12 s, there is practically only water left in the entire pipe.

FIG. 8 shows Pressure P(t) for the mud loss treatment fluid, here called “pre-swell” after 10 minutes of partial swelling in a pipe in a horizontal orientation, prior to release in horizontal orientation of the pipe of the mud loss treatment fluid (2) through a plate with seven 8 mm holes. Mainly all of the mud loss treatment fluid (2) has been forced out prior to t=1:26-0:14=12 s. Uppermost curve is the pressure Pi(t) immediately prior to the inlet of water at the beginning of the pipe, the lowermost curve pressure Po(t) by the outlet of the pipe. Experiment name: “Pre-swell 1 LM-Horiz 2010W-3000-690P-P-O-W-24HrsSwell-7x8mmR-PlasticSeal-Airfree”

### DETAILED DESCRIPTION

The invention provides a hydrophilic drilling mud loss treatment fluid (2), where the hydrophilic drilling mud loss treatment fluid (2) comprises ingredients in the form of:
a first granulate amount (1m) of water swellable hydrophilic polymer granules (1);
a first water amount (4m) of a first water (4) for partly swelling of the first granulate amount (1m);
a first oil amount (3m) of a first hydrophobic oil (3) being inert vis-à-vis the water swellable hydrophilic polymer granules (1);
and where the hydrophilic drilling mud loss treatment fluid (2) is formed by mixing the first granulate amount (1m) of the water swellable hydrophilic polymer granules (1) and the first water amount (4m) and the first hydrophobic oil amount (3) to form partly swelled hydrophilic polymer granules (1P) with a hydrophobic oil film (3f) formed between the partly swelled hydrophilic polymer granules (1P).

The hydrophilic drilling mud loss treatment fluid (2) is arranged to be stored in a drilling pipe string born tank (6) in a drilling pipe string (5) behind a drill bit (7), where the drilling mud loss treatment fluid (2) is arranged to be pressured out through a tank outlet (61) to a main bore (5B) in the drilling pipe string (5), where the drilling mud loss treatment fluid (2) after the passage through the tank outlet (61) is arranged to be mixed with a second water (4a) from passing hydrous drilling fluid (8) in the main bore (5B) and be transported with the drilling fluid (8) out through nozzles (7D) in the drill bit (7), and furthermore penetrate a mud loss zone surrounding a bore hole (9), where it continues to swell with the second water (4a) as well as formation water. If we surmise that the first water amount (4m) of the first water (4) constitutes of approx. 3 times the first granulate amount (3m) of the first water swellable hydrophilic polymer granules (1), the partly swelled hydrophilic polymer granules (1P) may swell further with a greater amount of the second water (4a), for example approx. 57 parts of the second water (4a) being taken partly from water in the drill mud, and partly from the formation, depending on what is available and the nature of the exposure times at the time. This is if one part polymer granule (1) is arranged to swell approx. 60 ggr. with water. Other swelling rates may apply depending on the composition of the hydrophilic polymer.

The invention also provides a method for preventing drilling mud loss during drilling, comprising:
providing a hydrophilic drilling mud loss treatment fluid (2), where the hydrophilic drilling mud loss fluid (2) comprises ingredients in the form of:
a first granulate amount (1m) of water swellable hydrophilic polymer granules (1),
a first water amount (4m) of a first water (4) for partly swelling of the first granulate amount (1m),
a first oil amount (3m) of a first hydrophobic oil (3) being inert vis-à-vis the water swellable hydrophilic polymer granules (1),
mixing the first granulate amount (1m) of the water swellable hydrophilic polymer granules (1) and the first water amount (4m) and the first hydrophobic oil amount (3) to partly swelled hydrophilic polymer granules (1P) with a hydrophobic oil film (3f) between the partly swelled hydrophilic polymer granules (1P), for the production of the hydrophilic drilling mud loss treatment fluid (2),
storing the hydrophilic drilling mud loss treatment fluid (2) in a drilling pipe string born tank (6) behind a drill bit (7) in a drilling pipe string (5),
running the drilling pipe string (5) into a well, and drilling under surveillance of any undesired drilling mud loss during drilling,
upon the occurrence of detection of undesired drilling mud loss, opening a tank outlet (61) from the drilling pipe string born tank (6) and pressing out the drilling mud loss treatment fluid (2) through the tank outlet (61) to a main bore (5B) in the drilling pipe string (5), where the drilling mud loss treatment fluid (2) after passage through the tank outlet (61) is mixed with a second water (4a) from passing hydrous drilling fluid (8) in the main bore (5B) and is transported with the drilling fluid (8) out through nozzles (7D) in the drill bit (7) and furthermore penetrating into the mud loss zone surrounding the bore hole (9) where it continues to swell with the second water (4a) and formation water, reducing or stopping the undesired drilling mud loss.

The invention contradicts previous practice. Previous practice has been to, more or less by any means necessary, avoid contact between water and the water swellable polymer granules (1), to now to allow a first amount (1m) of the water swellable polymer granules (1) for a controlled contact with a limited amount (4m) of a first water (4) prior to tank storage. The first amount (4m) of the first water (4), which is partly swelling the first amount (1m) of the water swellable polymer granules (1), for example in a ratio of 3:1, is significantly smaller than the amount of the second water (4a) which can be absorbed into the partly swellable polymer granules (1P). This second amount of the second water (4a) can be up to an additional 57 parts of the second water (4a) in relation to the first amount (4m) that can continue to swell in the second water (4a) which is available in the well fluid or in the form of formation water. The amount of water that can be absorbed by water in the polymer granules (1) is depending on the hydrophilic polymer's composition, but one applied type can absorb until it swells up to 60 times its original volume.

A embodiment of the invention is shown in FIG. 4 where the starting point is the first granulate amount (1m) of water swellable polymer granules (1), the first oil amount (3m) of the first hydrophobic oil (3) is added, so that the polymer granules (1) have been oil wet, and the first water amount (4m) of the first water (4) is added for partly swelling, and stirring it all to the hydrophilic drilling mud loss treatment fluid (2) of partly swelled hydrophilic polymer granules (1P) with hydrophobic oil film (3f) formed between these partly swelled hydrophilic polymer granules (1P). However, there is a certain risk of mutual adherence between the hydrophilic partly swelled polymer granules (1,1P) by not involving a sufficient distribution of the first oil amount (3m) early in the process, and so the granules must be oil wet in an embodiment. In an embodiment of the invention, the starting point is with dry polymer granules (1), where the oil is mixed in to form oil wet polymer granules (3), and this oil is utilized in such an amount that there is no excess oil, and the first water (4) is added, whereupon 2 minutes of stirring is required in order to form the drilling mud loss treatment fluid (2) where the first water is absorbed in the partly swelled polymer granules (1).

In an embodiment of the invention, the hydrophilic drilling mud loss treatment fluid (2) is formed by mixing the first granulate amount (1m) of the water swellable polymer granules with the first oil amount (3m) in order to make the first water swellable polymer granules oil wet, and then mix this with the first water amount (4m), and mix this to form the hydrophilic drilling mud loss treatment fluid (2).

So far, we have also lubricated the steel walls in chambers and pipes in order to reduce friction prior to pumping of the drilling mud loss treatment fluid (2).

A technical effect of the invention is that with this hydrophilic drilling mud loss treatment fluid (2) one may avoid previous problems with “dry” granules stored in oil in the annular tank (6), where one may surmise that an uncontrolled local contact with water, with a subsequent blocking of granules has occurred in the outlet, causing the outlet (61) and even the annular tank (6) to become clogged, as shown in FIG. 3C.

A considerable advantage with the drilling mud loss treatment fluid (2) comprising the partly swelled polymer granules (4P) is that a small water leakage from drilling mud into the tank in the dril string due to high pressure and significant mechanical BHA strains will be able to be absorbed and/or dispersed in the significantly larger amount of the drilling mud loss treatment fluid (2) in the tank without changing the drilling mud loss treatment fluid's (2) properties much; the polymer granules have already begun to partly swell.

An advantageous technical effect is that it is practically possible to press the drilling mud loss treatment fluid (2) out through a tank outlet. The partly swelling into something emollient and perhaps less rough hydrophilic partly swelled hydrophilic polymer granules (1P) and the hydrophobic oil film (3f) may lead to the drilling mud loss treatment fluid (2) getting a viscosity which allows the drilling mud loss treatment fluid (2) to be pressed out through nozzle openings, which often are narrower than the partly swelled granule size of the granulates (1P). In an embodiment of the invention, the hydrophilic polymer granules (1) are often up to 2 mm, but still after pre-swelling with approx. three times the amount of the first water (4), where they achieve a size larger than 2 mm, they allow themselves to be pressed out fine through 2 mm nozzles. Here, we refer to the attached laboratory experiment results with 2 mm nozzle openings in the restrictor plate in the pipe end.

In an embodiment of the invention, the hydrophilic drilling mud loss treatment fluid (2) is formed according to the invention by:
mixing the first water amount (4m) and the first hydrophobic oil amount (3m) and stir it to form an intermediate fluid (4i) of dispersed droplets of hydrophobic oil (3) in the first water amount (4m), and
mixing the intermediate fluid (4i) with the first granulate amount (1m), and
stirring this during a first duration (T1) to the hydrophilic drilling mud loss treatment fluid (2).

The above-mentioned embodiment is illustrated in FIG. 5.

This way of mixing it will make sure that the first hydrophobic oil amount (3) will enter inbetween the partly swelled hydrophilic polymer granules (1P) and will prevent that the partly swelled hydrophilic polymer granules (1P) from clotting. One may then achieve that the drilling mud loss treatment fluid (2) forms a stable mass with an appropriate viscosity, and advantageous pumping properties through a tank outlet (61). Another observation we have made during laboratory experiments is that one may experience a coherent mass of the drilling mud loss treatment fluid (2) through a plate with several nozzles, also after the nozzles, or what is also called “non-fingering” through a restriction with several openings as an outlet valve in a tank outlet (61) and for example via a ball catcher.

In the experiments carried out for this invention, the first granulate amount (1m) is taken from a container delivered by the manufacturer SNF SA, FR, in the form of a product DP/SB 3820-3 with “dry” delivered water swellable polymer granules (1) in the shape of angular, crushed flakes of up to 2 mm, to be stored in a sealed container to prevent water from the air to initiate swelling. The superabsorbent polymer utilized can also be delivered in sealed containers also containing storage oils. In any case, both these storage forms of dry powder or stored in oil are non-conducive for further storage in a carrier sub, a tank section in a dril string to be lowered into a well; nearly any water penetration from drilling mud may incur uncontrolled swelling and thus clogging of the water swellable polymer granules, and that one becomes unsuccessful in ejecting the water swellable polymer granules out of the tank, out through the drill bit's (7) nozzles (7D), and out to the fractures in the formation, in an effort to limit or block these through swelling polymer granules.

An advantage of the invention is that the drilling mud loss treatment fluid (2), when stored in the tank, to be passed out through the tank outlet (61) mainly comprises the partly swelled hydrophilic polymer granules (1P) and a relatively smaller amount of the first hydrophobic oil (3), and that the partly swelled hydrophilic polymer granules (1P), even though they have swelled more than approx. three times its original non-hydrous granule size, are now ductile and more plastic, and separated and lubricated by a film of the first hydrophobic oil (3), and possess the ability to penetrate through passages with a passage diameter which is slightly less than the pre-swelled hydrophilic polymer granules' (1P) diameter. This is apparent through the results of the experiments by pushing the drilling mud loss treatment fluid (2) through a plate with 7 holes with 2 mm openings, see FIGS. 6A and 6B.

In an embodiment of the invention, the hydrophilic drilling mud loss treatment fluid (2) is formed by:
providing a pre-mixed amount of the first granulate amount (1m) which has been stored in a first hydrophobic oil (3L),
supplying the first hydrophobic oil (3) until one achieves the first hydrophobic oil amount (3m), and
mixing this with the first water amount (4m), and
mixing this in a first duration (T1) to the drilling mud loss treatment fluid (2)

In an embodiment of the invention, the first hydrophobic oil (3) is arranged to, during storage and during passage through the tank outlet (61), constitute a film, the hydrophobic oil film (3f), enveloping the partly swelled polymer granules (1P) and to be exposed to shearing forces during passage out through the tank outlet (61), resulting in the at least partly release from the partly swelled hydrophilic polymer granules (1P) so that they are exposed to the second water (4a) in the hydrous drilling fluid (8) and continuing to swell. Equivalently, the partly swelled polymer granules (1P) are arranged to be exposed to shearing forces through the nozzles (7d) in the drill bit (7) so that they are exposed to the second water and continue to swell from the partly swelled phase on its path towards cracks in the formation and continuing to swell in the second water (4a).

In an embodiment of the invention, the polymer granules (1) are a crushed powder of dry, potentially water swelling polymer. In a further embodiment, the powder has a granule size distribution up to 2 mm.

In an embodiment of the invention, in the demonstrated, experimentally utilized production of the drilling mud loss treatment fluid utilized in the experiments behind the curves in FIGS. 6, 7, and 8, the mixing ratio is such that the first water amount (4m) of the first water (4) is 6030 ml, (67%), and wherein the first oil amount (3m) of the first oil (3) is 900 ml (10%).

TABLE 1
for water share in relation to powder share (vol %)
at using 10% hydrophobic oil (3)

| | ml. used | Low water | | Higher |
|---|---|---|---|---|
| | inmixture | % | applied | water % |
| Water swellable | 690 | 30 | 23 | 18 |
| powder (1) | | | | |
| Water (4) | 2010 | 60 | 67 | 72 |
| First oil (3) | 300 | 10 | 10 | 10 |
| Total | 3000 | 100 | 100 | 100 |

TABLE 2
for varyingly amount of hydrophobic oil (3) between
5 and 12% (vol.)

| | | | | Higher |
|---|---|---|---|---|
| | ml. used in | Low water | | water and |
| | mixture | and oil % | used | oil % |
| Water | | 32 | 23 | 20 |
| swellable | | | | |
| powder (1) | | | | |
| First water (4) | | 63 | 67 | 68 |
| Oil (3) | | 5 | 10 | 12 |
| Total | | 100 | 100 | 100 |

In an embodiment of the invention, the amount ratios are such that they constitute:
the first water amount (4m) of the first water (4) is 60 to 72%,
the first granulate amount (1m) of water swellable hydrophilic polymer granules (1) is 18 to 30%, and
the first oil amount (3m) of the first oil (3) is 5 to 12% of the total amount of the drilling mud loss treatment fluid (2).

| | List of components |
|---|---|
| 1 | polymer granules 1 of water swelling type |
| 1m | first amount 1 m of first polymer granules 1 |
| 1P | partly swelled polymer granules |
| 2 | partly swelled mass |
| 3 | a first amount of oil (3 m) of a first oil which is inert |
| 3m | with regard to the polymer granules (1) |
| 4 | a first amount (4 m) of first water (4) for partly swelling |
| 4m | the second water (4a) in drilling mud and/ |
| 4a | or the formation |
| 5 | drill pipe string |
| 5B | main bore (5B), central channel in tool and drill string |
| 6 | drill pipe conveyed tank |
| 7 | drill bit |
| 7B | drill bit |
| 7D | nozzles (7D) in drill bit (7B) |
| 8 | drilling fluid, water based |
| 9 | |
| 10 | mud loss zone 10 |
| 60 | inlet to tank |
| 61 | outlet from tank |
| 62 | piston |
| 63 | outlet diverter sub |
| 64 | inlet diverter sub |
| 65 | blocking organ, ball, obturator |
| 66 | ball seat |
| 67 | burst disc |
| 68 | double wall pipe which constitute inner- and outer pipe |
| | in the drill pipe string conveyed annular tank (6) |

1. A hydrophilic drilling mud loss treatment fluid comprising
a first granulate amount of water swellable hydrophilic polymer granules
a first water amount of a first water for partly swelling of the first granulate amount,
a first oil amount of a first hydrophobic oil being inert to the water swellable polymer granules,
wherein the drilling mud loss treatment fluid is formed by mixing the first granulate amount of the water swellable hydrophilic polymer granules and the first water amount and the first hydrophobic oil amount to partly swelled hydrophilic polymer granules with a hydrophobic oil film formed between the partly swelled hydrophilic polymer granules.

2. The hydrophilic drilling mud loss treatment fluid according to claim 1,
formed by mixing the first granulate amount of the water swellable polymer granules with the first oil amount, thereby causing the first water swellable polymer granules to become initial oil wet granules, subsequently mixing the initial oil wet granules with the first water amount, and continuing mixing to form the hydrophilic drilling mud loss treatment fluid.

3. The hydrophilic drilling mud loss treatment fluid according to claim 1, formed by:
mixing the first water amount and the first hydrophobic oil amount and stirring into an intermediary fluid of dispersed droplets of the first hydrophobic oil in the first water amount,
mixing the intermediary fluid with the first granulate amount and stirring to form the hydrophilic drilling mud loss treatment fluid.

4. The hydrophilic drilling mud loss treatment fluid according to claim 1, formed by:
extracting a pre-mixed amount of the first granulate amount having been stored in a first hydrophobic oil or having been supplemented with the first hydrophobic oil until obtaining the first hydrophobic oil amount and mixing with the first water amount to form the hydrophilic drilling mud loss treatment fluid.

5. The drilling mud loss treatment fluid according to claim 1, wherein
the first hydrophobic oil is arranged for, during storage and passage through the tank outlet, to constitute a hydrophobic oil film, about the partly swelled polymer granules, and is exposed to shearing forces during passage out through the tank outlet resulting in the at least partial release from the partly swelled hydrophilic polymer granules causing them to be exposed to the other water in the hydrous drilling fluid and continue to swell.

6. The drilling mud loss treatment fluid according to claim 1,
wherein the polymer granules are a crushed powder of dry, water swelling polymer with a granule size distribution of up to 2 mm.

7. The drilling mud loss treatment fluid according to claim 1, wherein
the first water amount of the first water constitutes 60 to 72%,
the first granulate amount of water swelling hydrophilic polymer granules constitutes 18 to 30%, and
the first oil amount of the first oil constitutes 5 to 12% of the total amount of the drilling mud loss treatment fluid.

8. A method for preventing drilling mud loss during drilling, comprising:
providing a hydrophilic drilling mud loss treatment fluid, the hydrophilic drilling mud loss treatment fluid comprising ingredients in the form of:
a first granulate amount of water swelling hydrophilic polymer granules;
a first water amount of a first water for partly swelling of the first granulate amount;
a first oil amount of a first hydrophobic oil being inert to the water swelling polymer granules;
mixing the first granulate amount of the water swelling hydrophilic polymer granules and the first water amount and the first hydrophobic oil amount to partly swelled hydrophilic polymer granules with a hydrophobic oil film being formed between the partly swelled hydrophilic polymer granules for production of the hydrophilic drilling mud loss treatment fluid;
storing the hydrophilic drilling mud loss treatment fluid in a drill pipe string bearing tank behind a drill bit in a drill pipe string;
guiding the drill pipe string into a well, and drilling while monitoring of any undesired drilling mud loss during drilling;
upon detection of drilling mud loss, opening a tank outlet from the drill pipe string borne tank and forcing out the drilling mud loss treatment fluid through the tank outlet to a main bore in the drill pipe string, the drilling mud loss treatment fluid, after the passage through the tank outlet, being mixed with a second water from passing hydrous drilling fluid in the main bore, and transported with the drilling fluid out through nozzles in the drill bit and further penetrated into the mud loss zone surrounding the bore hole, where it continues to swell with the second water and formation water, thereby reducing or stopping the mud loss.

9. The drilling mud loss treatment fluid according to claim 2, wherein
the first hydrophobic oil is arranged for, during storage and passage through the tank outlet, to constitute a hydrophobic oil film, about the partly swelled polymer granules, and is exposed to shearing forces during passage out through the tank outlet resulting in the at least partial release from the partly swelled hydrophilic polymer granules causing them to be exposed to the other water in the hydrous drilling fluid and continue to swell.

10. The drilling mud loss treatment fluid according to claim 3, wherein
the first hydrophobic oil is arranged for, during storage and passage through the tank outlet, to constitute a hydrophobic oil film, about the partly swelled polymer granules, and is exposed to shearing forces during passage out through the tank outlet resulting in the at least partial release from the partly swelled hydrophilic polymer granules causing them to be exposed to the other water in the hydrous drilling fluid and continue to swell.

11. The drilling mud loss treatment fluid according to claim 4, wherein
the first hydrophobic oil is arranged for, during storage and passage through the tank outlet, to constitute a hydrophobic oil film, about the partly swelled polymer granules, and is exposed to shearing forces during passage out through the tank outlet resulting in the at least partial release from the partly swelled hydrophilic polymer granules causing them to be exposed to the other water in the hydrous drilling fluid and continue to swell.

12. The drilling mud loss treatment fluid according to claim 11,
wherein the polymer granules are a crushed powder of dry, water swelling polymer with a granule size distribution of up to 2 mm.

13. The drilling mud loss treatment fluid according to claim 2,
wherein the polymer granules are a crushed powder of dry, water swelling polymer with a granule size distribution of up to 2 mm.

14. The drilling mud loss treatment fluid according to claim 3,
wherein the polymer granules are a crushed powder of dry, water swelling polymer with a granule size distribution of up to 2 mm.

15. The drilling mud loss treatment fluid according to claim 4,
wherein the polymer granules are a crushed powder of dry, water swelling polymer with a granule size distribution of up to 2 mm.

16. The drilling mud loss treatment fluid according to claim 12, wherein
the first water amount of the first water constitutes 60 to 72%,
the first granulate amount of water swelling hydrophilic polymer granules constitutes 18 to 30%, and
the first oil amount of the first oil constitutes 5 to 12% of the total amount of the drilling mud loss treatment fluid.

17. The drilling mud loss treatment fluid according to claim 2, wherein
the first water amount of the first water constitutes 60 to 72%,
the first granulate amount of water swelling hydrophilic polymer granules constitutes 18 to 30%, and
the first oil amount of the first oil constitutes 5 to 12% of the total amount of the drilling mud loss treatment fluid.

18. The drilling mud loss treatment fluid according to claim 3, wherein
the first water amount of the first water constitutes 60 to 72%,
the first granulate amount of water swelling hydrophilic polymer granules constitutes 18 to 30%, and
the first oil amount of the first oil constitutes 5 to 12% of the total amount of the drilling mud loss treatment fluid.

19. The drilling mud loss treatment fluid according to claim 4, wherein
the first water amount of the first water constitutes 60 to 72%,
the first granulate amount of water swelling hydrophilic polymer granules constitutes 18 to 30%, and
the first oil amount of the first oil constitutes 5 to 12% of the total amount of the drilling mud loss treatment fluid.
